(19) United States
(12) Patent Application Publication
(10) Pub. No.: US 2020/0194935 A1
(43) Pub. Date: Jun. 18, 2020

(54) Electrically Conductive Trim Connector Assembly For A Seat

(71) Applicant: Lear Corporation, Southfield, MI (US)

(72) Inventors: David Gallagher, Sterling Heights, MI (US); Lisa Townley, Brownstown, MI (US)

(73) Assignee: Lear Corporation, Southfield, MI (US)

(21) Appl. No.: 16/221,979

(22) Filed: Dec. 17, 2018

(51) Int. Cl. H01R 13/639; B60N 2/58

(52) U.S. Cl. CPC H01R 13/639; H01R 2201/26; B60N 2/5825

(57) ABSTRACT

A trim attachment for a vehicle includes a trim layer having an electrically conductive trim material forming a first electrical circuit, a supporting structure supporting the trim layer, and an electrically conductive attachment member with first and second portions. The first portion is fixed to the trim layer and the second portion is fixed to the supporting structure. The first and second portions are adapted to both selectively resist separation of the trim layer and the supporting structure and to electrically connect the first electrical circuit to a second electrical circuit that is external to the trim layer. The first and second portions may both resist separation of the trim layer and the supporting structure and electrically connect the first and second electrical circuits at a contact surface between the first and second portions.

### BACKGROUND OF THE INVENTION

This invention relates in general to connector assemblies that attach trim materials to supporting structures for seats. In particular, this invention relates to an improved structure for such a connector assembly that provides both a mechanical connection and an electrically conductive connection between an electrically conductive trim material and a seat supporting structure.

A seat, such as is commonly used in an automotive vehicle, typically includes a supporting structure, a cushioning foam bun that is supported on the supporting structure, and a finish trim layer that is wrapped around or otherwise covers the foam bun. An occupant of the vehicle seat contacts the finish trim layer when sitting on the vehicle seat. The finish trim layer may be formed from an electrically conductive material, such as an electrically conductive smart material or a piezoelectric material, and may be selectively energized by an electrical current to provide functionality for the seat. For example, the finish trim layer may be energized to provide heating for the comfort of the occupant of the seat.

During assembly of the vehicle seat, the finish trim layer is typically installed on the foam bun. Installation of the finish trim layer over the foam bun often includes using mechanical fasteners to retain the finish trim layer in an installed position on the foam bun. These mechanical fasteners resist compression, tension, and/or shear forces that may be imposed on the finish trim layer by the occupant sitting in the seat. The forces imposed by the occupant of the seat tend to separate or otherwise uninstall the finish trim layer from the foam bun. For the electrically conductive material of the finish trim layer to be energized, electrical connectors are used to connect the electrically conductive material of the trim material to a source of electrical energy. These electrical connectors resist forces that would disconnect the electrically conductive material of the trim material from the source of electrical energy.

The use of both the mechanical fasteners and the electrical connectors increases complexity and cost of installing the finish trim layer on the foam bun when assembling the vehicle seats. Thus, it would be desirable to provide an improved structure for a connector assembly that provides both mechanical and electrical connections for vehicle seats that avoids these issues.

### SUMMARY OF THE INVENTION

This invention relates to an improved connector assembly providing both mechanical and electrical connections for a vehicle seat. The electrically conductive connector assembly has first and second connectors. The first connector is fixed to a trim layer for the vehicle seat and the second connector is fixed to a supporting structure of the vehicle seat. The first and second connectors are adapted to have both the mechanical and electrical connections. The mechanical connection selectively resists separation of the finish trim layer and the supporting structure. The electrical connection electrically connects the electrically conductive finish trim layer to an electrical circuit that is external to the trim layer. Although not necessary, the first and second connectors may have both the mechanical and electrical connections at a single contact surface between the first and second connectors.

The electrically conductive trim material may be one of an electrically conductive smart material or a piezoelectric material. Alternatively, electrical conductivity may be added to a known, non-electrically conductive connector. Such electrical conductivity may be added using electrically conductive thread, ink, or paint. As non-limiting examples, each of the connectors may take the form of an arrow and clip connector, j-retainer connector, arrow and j-retainer connectors, interlocking teeth connector (e.g., a zipper), ring connector (e.g., a hog ring), or a hook and loop connector (e.g., a Velcro-type fastener). The electrical connection is provided without altering external dimensions that each of the connectors would otherwise have if the electrical connection was omitted. Thus, any of the connectors may be utilized with existing vehicle seat assembly techniques, equipment, and best practices for installing the finish trim layer on the supporting structure.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a vehicle seat including an electrically conductive connector assembly in accordance with this invention.

FIG. 2 is an enlarged section view taken along line 2-2 of FIG. 1.

FIG. 3 is a section view of an arrow connector for the connector assembly of FIG. 1.

FIG. 4 is a section view of the arrow connector of FIG. 3 having an electrically conductive thread.

FIG. 5 is a section view of the arrow connector of FIG. 3 having an electrically non-conductive thread.

FIG. 6 is a section view of the arrow connector of FIG. 3 having a unitary body member and barb.

FIG. 7 is a section elevation view of the arrow connector of FIG. 3 having a fully electrically conductive barb in a disengaged state with a receiver clip connector.

FIG. 8 is section view of the arrow connector of FIG. 7 in an engaged state.

FIG. 9 is a section view of the arrow connector of FIG. 3 having an electrically conductive tip in a disengaged state with a receiver clip connector.

FIG. 10 is section view of the arrow connector of FIG. 9 in an engaged state.

FIG. 11 is a section view of the arrow connector of FIG. 3 having an electrically insulated barb in a disengaged state with a receiver clip connector.

FIG. 12 is section view of the arrow connector of FIG. 11 in an engaged state.

FIG. 13 is a perspective view of the arrow connector of FIG. 3.

FIG. 14 is a perspective view of an alternate arrow connector of FIG. 3.

FIG. 15 is an elevation view of a j-retainer connector for the connector assembly of FIG. 1 in a disengaged state.

FIG. 16 is an elevation view of the j-retainer connector of FIG. 15 in an engaged state.

FIG. 17 is an elevation view of arrow and j-retainer connectors for the connector assembly of FIG. 1 in a disengaged state.

FIG. 18 is an elevation view of the arrow and j-retainer connectors of FIG. 17 in an engaged state.

FIG. 19 is a perspective view of a portion of the vehicle seat illustrated in FIG. 1 including a variation of the j-retainer of FIG. 15.

FIG. 20 is a section view taken along line 20-20 of FIG. 19.

FIG. 21 is an elevation view of an interlocking teeth connector for the connector assembly of FIG. 1.

FIG. 22 is an enlarged portion of FIG. 21.

FIG. 23 is a perspective view of a first ring connector for the connector assembly of FIG. 1 in a disengaged state.

FIG. 24 is a perspective view of the ring connector of FIG. 23 in an engaged state.

FIG. 25 is a perspective view of a second ring connector for the connector assembly of FIG. 1 in a disengaged state.

FIG. 26 is a perspective view of the ring connector of FIG. 25 in an engaged state.

FIG. 27 is a perspective view of a hook and loop connector for the connector assembly of FIG. 1.

### DETAILED DESCRIPTION OF THE PREFERRED EMBODIMENTS

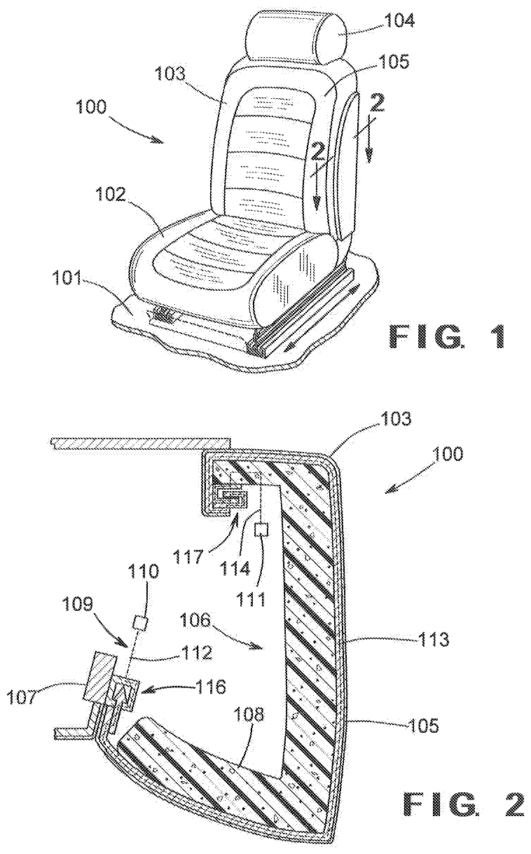

Referring now to the drawings, there is illustrated in FIGS. 1 and 2 a vehicle seat, indicated generally at 100, that may, for example, be disposed within an automobile or other vehicle. The vehicle seat 100 is mounted on a floor 101 or other support surface of the vehicle and includes a seat bottom 102 and a seat back 103. The seat back 103 may be movable (such as pivotable, for example) or fixed relative to the seat bottom 102. The seat back 103 has an optional headrest 104 attached thereto, opposite the seat bottom 102. The headrest 104 may be a separate component or integrated into the seat back 103.

A layer 105, such as a preferably flexible finish trim layer for the vehicle seat 100, covers at least portions of the surfaces of the seat bottom 102, the seat back 103, and the headrest 104 upon which an occupant (not shown) of the vehicle seat 100 sits or otherwise contacts. As non-limiting examples, the finish trim layer 105 may be vinyl, cloth, natural leather, or synthetic leather material.

As shown in FIG. 2, the vehicle seat 100 further includes a supporting structure, indicated generally at 106, that is covered by the finish trim layer 105. The supporting structure 106 underlies and provides structural support for the finish trim layer 105. As a result, a shape of the supporting structure 106 defines a corresponding shape of the finish trim layer 105. As illustrated, the supporting structure 106 includes a frame member 107 as well as a foam bun 108, but may also include other members or components such as, for example, fleece material or other types of padding. The frame member 107 and the foam bun 108 structurally support the finish trim layer 105.

FIG. 2 also shows an electrical circuit, indicated generally at 109 and shown by dashed lines, between first and second electrical terminals 110 and 111, respectively. The illustrated electrical circuit 109 has three interconnected portions, namely, a first circuit portion 112 that extends from the first terminal 110 to the finish trim layer 105, a second circuit portion 113 that is incorporated into and extends through the finish trim layer 105, and a third circuit portion 114 that extends from the finish trim layer 105 to the second terminal 111. Thus, the first and third circuit portions 112 and 114, respectively, are external to the finish trim layer 105. Any or all of the first, second, or third circuit portions 112, 113, and 114, respectively, may each be divided into further interconnected circuit portions (not shown) if desired.

Either or both of the first and third circuit portions 112 and 114, respectively, may be embodied as conventional metallic electrical conductors, such as wires, that are supported by the supporting structure 106 of the vehicle seat 100. When the electrical conductors of the first and third circuit portions 112 and 114, respectively, are separate from and/or readily removable from the supporting structure 106, the electrical conductors are not considered part of the supporting structure 106. Alternatively, either or both of first and third circuit portions 112 and 114, respectively, may be directly incorporated into the supporting structure 106 and, as such, are not readily removable from the supporting structure 106. As non-limiting examples, either or both of the first and third circuit portion 112 and 114, respectively, may be incorporated into the frame member 107 when the frame member 107 is fabricated from an electrically conductive material, such as steel or aluminum (i.e., the frame member 107 itself is the electrical conductor) or the foam bun 108 when the foam bun 108 is fabricated from an electrically conductive foam material.

The second circuit portion 113 is incorporated or otherwise integrated into the finish trim layer 105 such that the second circuit portion 113 may not be readily removed or otherwise separated from the finish trim layer 105. The second circuit portion 113 is incorporated into the finish trim layer 105 such that any removal of the second circuit portion 113 from the finish trim layer 105 would typically damage or otherwise render the finish trim layer 105 unsuitable for use with the vehicle seat 100. The second circuit portion 113 is formed from an electrically conductive trim material. The electrically conductive trim material may be an entirety of the finish trim layer 105 or may be less than the entirety of the finish trim layer 105.

As non-limiting examples, the finish trim layer 105 at the second circuit portion 113 may be formed from an electrically conductive smart material (as the term “electrically conductive smart material” is known to those skilled in the art) or a piezoelectric material. Such electrically conductive finish trim materials are commercially available from, for example, Noble Conductive Foams, Gilford Conductive Textiles, EO Conductive Leathers, and Xonano Piezo-Foams. Alternatively, as a further non-limiting example, the finish trim layer 105 at the second circuit portion 113 may be a non-electrically conductive finish trim material to which electrical conductivity has been added. As non-limiting examples, electrical conductivity may be added by weaving an electrically conductive thread into known fabric material or by applying electrically conductive ink to known leather material. Such electrically conductive ink is commercially available from, for example, Bare Ink.

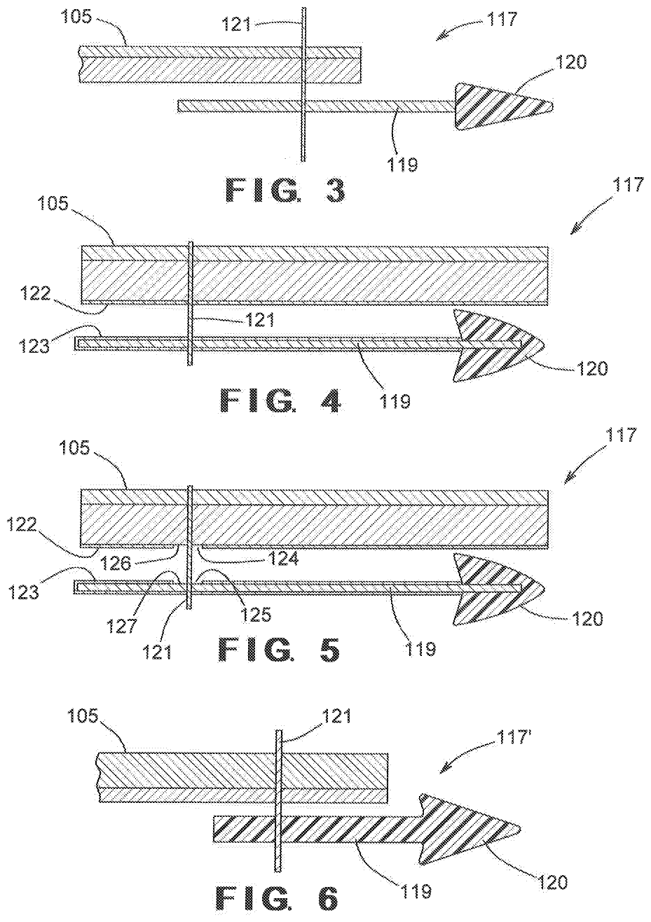

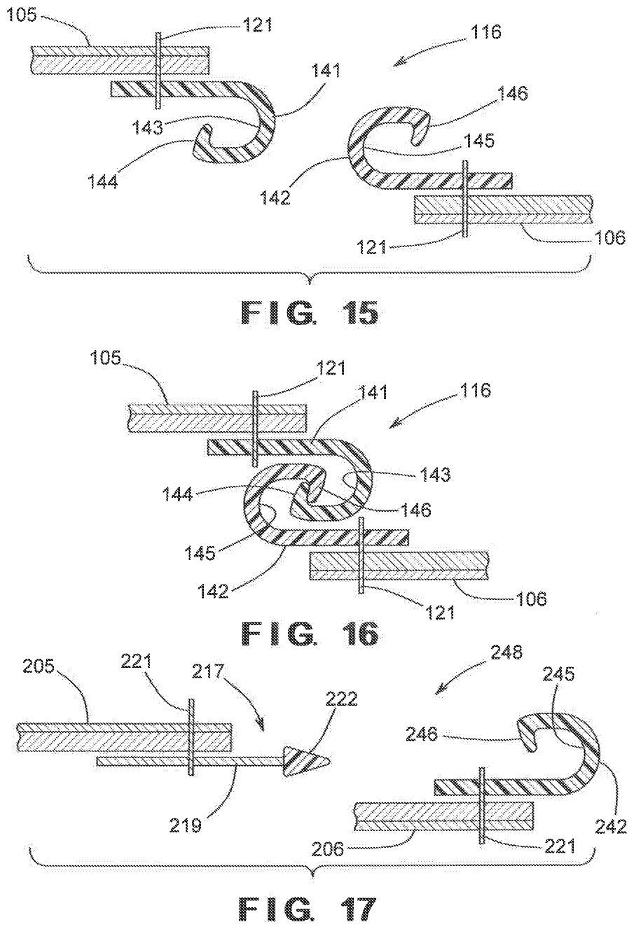

FIG. 2 illustrates first and second embodiments of connector assemblies, indicated generally at 115 and 116, respectively. As will be discussed, each of the first and second connector assemblies 115 and 116, respectively, selectively engages together to provide both a mechanical connection and an electrical connection between the finish trim layer 105 and the supporting structure 106. The first connector assembly 115 will be discussed in detail with reference to FIGS. 3-14 and the second connector assembly 116 will be discussed in detail with reference to FIGS. 15 and 16.

The mechanical connection provided by each of the first and second connector assemblies 115 and 116, respectively, is between the finish trim layer 105 and the supporting structure 106. The mechanical connection retains the finish trim layer 105 on the supporting structure 106 (e.g., the frame member 107 and/or the foam bun 108) and resists or otherwise prevents separation, disassembly, or other uninstallation of the finish trim layer 105 from the supporting structure 106.

The electrical connection provided by each of the first and second connector assemblies 115 and 116, respectively, completes the electrical circuit 109. The first connector assembly 115 provides a first electrical connection and completes the electrical circuit 109 between the first and second circuit portions 112 and 113, respectively. The second connector assembly 116 provides a second electrical connection and completes the electrical circuit 109 between the second and third circuit portions 113 and 114, respectively. Furthermore, either of the first or second connector assemblies 115 or 116, respectively, may be used unaltered to provide the mechanical connection only, such as when the electrical circuit 109 is omitted from the vehicle seat 100.

As illustrated, the first connector assembly 115 provides the mechanical connection between the finish trim layer 105 and the frame member 107 and the second connector assembly 116 provides the mechanical connection between the finish trim layer 105 and the foam bun 108. Alternatively, the first connector assembly 115 may provide the mechanical connection between the finish trim layer 105 and the foam bun 108 and the second connector assembly may provide the mechanical connection between the finish trim layer 105 and the frame member 107.

FIGS. 3-14 illustrate the first connector assembly 115 in detail. The first connector assembly 115 includes an arrow connector, indicated generally at 117, and a receiver clip connector 118. The first connector assembly 115 may be utilized with existing assembly techniques, equipment, and best practices for installing the finish trim layer 105 on the supporting structure 106. As illustrated, the arrow connector 117 is fixed to the finish trim layer 105 and the receiver clip connector 118 is fixed to the supporting structure 106 at the frame member 107. Alternatively, the arrow connector 117 may be fixed to the supporting structure 106 at the frame member 107 and the receiver clip connector 118 may be fixed to the finish trim layer 105.

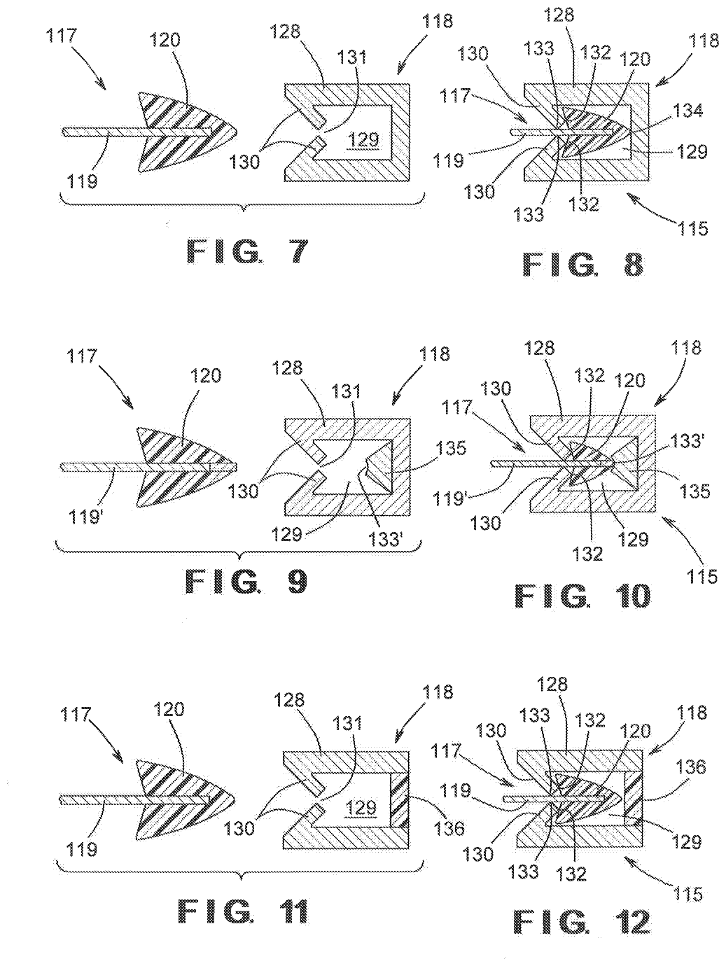

The first connector assembly 115 is selectively operable between an engaged state and a disengaged state. In the engaged state of the first connector assembly 115, the arrow connector 117 and the receiver clip connector 118 are engaged together to provide the mechanical connection to retain the finish trim layer 105 on the supporting structure 106 and the electrical connection to complete the electrical circuit 109. In the disengaged state, the arrow connector 117 and the receiver clip connector 118 are separated such that the trim and electrical connections are not provided, the finish trim layer 105 is not retained on the supporting structure 106, and the electrical circuit 109 is not completed. The engaged and disengaged states will be discussed further with reference to FIGS. 7-12.

Referring specifically to FIG. 3, the arrow connector 117 includes an electrically conductive body member 119 and barb 120 at an end of the body member 119. As will be discussed, the barb 120 may or may not be electrically conductive. As illustrated, the barb 120 has a generally arrowhead or otherwise triangular shape that is symmetric (as illustrated) across the body member 119. As illustrated further, the body member 119 and the barb 120 are separately formed members joined together using suitable means known to those skilled in the art. Alternatively, and as will be discussed, the arrow connector 117 may be otherwise formed.

The arrow connector 117 is fixed to the finish trim layer 105. As illustrated in FIG. 3, the body member 119 is fixed or otherwise secured to the finish trim layer 105 by a fixing member 121. The fixing member 121 provides both the mechanical and electrical connections between the body member 119 and the finish trim layer 105. As a result, the arrow connector 117 is electrically conductive between the body member 119 and the finish trim layer 105. In FIGS. 4 and 5, the fixing member 121 is illustrated as a thread. Alternatively, the fixing member 121 may be other than a thread. As non-limiting examples, the fixing member 121 may be a snap, weld, or adhesive.

In FIG. 4, the finish trim layer 105 has a first electrical insulation coating 122 and the body member 119 has a second electrical insulation coating 123. The first and second insulation coatings 122 and 123, respectively, insulate the finish trim layer 105 and the body member 119 from direct electrical contact with each other. In FIG. 4, the fixing member 121 is an electrically conductive thread. As a result, the body member 119 is fixed to the finish trim layer 105 by the electrically conductive thread. The electrically conductive thread passes through openings in the first and second insulation coatings 122 and 123, respectively, that have sizes corresponding to a cross section of the electrically conductive thread.

The mechanical and electrical connections between the body member 119 and the finish trim layer 105 are made by the electrically conductive thread. As illustrated, the electrically conductive thread fixes the body member 119 and the finish trim layer 105 together with a gap or other separation between the body member 119 and the finish trim layer 105. Alternatively, the electrically conductive thread may fix the body member 119 and the finish trim layer 105 together by drawing the body member 119 and the finish trim layer 105 together such that there is no gap between the body member 119 and the finish trim layer 105 and the first and second insulation layers 122 and 123, respectively, contact each other.

In FIG. 8, the fixing member 121 is a non-electrically conductive thread. Also in FIG. 8, there is a first enlarged opening or other penetration 124 in the first insulation coating 122 and a second enlarged opening or other penetration 125 in the second insulation coating 123. Both the first and second openings 124 and 125, respectively, have greater areas than a cross section of the non-electrically conductive thread. As a result, when the body member 119 is fixed to the finish trim layer 105 by the non-electrically conductive thread, a first uninsulated portion 126 of the finish trim layer 105 and a second uninsulated portion 127 of the body member 119 are drawn together into direct, electrical contact with each other. As a non-limiting example, the first and second uninsulated portions 126 and 127, respectively, may be drawn together by deformation of the finish trim layer 105 and the body member 119.

The non-electrically conductive thread provides the mechanical connection between the finish trim layer 105 and the body member 119 and the direct, electrical contact between the first and second uninsulated portions 126 and 127, respectively, provides the electrical connection between the finish trim layer 105 and the body member 119. Alternatively, the conductive thread of FIG. 4 may be substituted for the non-electrically conductive thread in FIG. 5 with the first and second uninsulated portions 126 and 127, respectively, to improve conductivity of the electrical connection between the finish trim layer 105 and the body member 119.

FIG. 6 illustrates an alternate arrangement of the arrow connector 117 to what is illustrated in FIG. 3. In FIG. 6, an arrow connector 117′ has the body member 119 and the barb 120 molded or otherwise formed as a single, unitary, or monolithic structure.

Referring specifically to FIG. 7, there is illustrated the arrow connector 117 and the receiver clip connector 118 in a disengaged state. In FIG. 7, the barb 120 of the arrow connector 117 is electrically conductive. The receiver clip connector 118 has an electrically conductive body portion 128. The body portion 128 is hollow and includes a cavity 129 with opposing, electrically conductive flanges 130. An opening 131 into the cavity 129 is defined between the flanges 130.

In FIG. 8, the arrow connector 117 and the receiver clip connector 118 are in an engaged state. In the engaged state, the barb 120 and a portion of the body member 119 have entered the opening 131 (shown in FIG. 7) such that the barb 120 is inside the cavity 129. First contact surfaces 132 are defined between the barb 120 and the flanges 130. The barb 120 and the flanges 130 bear on each other at the first contact surfaces 132 to provide the mechanical connection for the first connector assembly 115. The first contact surfaces 132 prevent ready withdrawal of the barb 120 from the cavity 129 and separation of the arrow connector 117 from the receiver clip connector 118 (e.g., in a generally horizontal direction as the first connector assembly 115 is illustrated in FIG. 8). This retains the finish trim layer 105 on the supporting structure 106.

Also in the engaged state, when the barb 120 is inside the cavity 129, second contact surfaces 133 are defined between the barb 120 and the electrically conductive body member 119. The second contact surfaces 133 provide the electrical connection for the first connector assembly 115. The electrical connection at the second contact surfaces 133 completes the electrical circuit 109 (shown in FIG. 2).

The second contact surfaces 133 also provide additional mechanical connections for the first connector assembly 115. As a non-limiting example, the second contact surfaces 133 resist separation of the finish trim layer 105 from the supporting structure 106 in at least one direction perpendicular to each of the second contact surfaces 133 (e.g., in a generally vertical direction as the first connector assembly 115 is illustrated in FIG. 8). As a result, the second contact surfaces 133 provide both the mechanical and electrical connections. As described herein, when a contact surface provides both the mechanical and electrical connections, there is at least one specific point of the contact surface that provides both the mechanical and electrical connections. As described herein, a contact surface does not provide both the mechanical and electrical connections when a first specific point of the contact surface provides one of the mechanical and electrical connections, a second specific point of the contact surface provides the other of the mechanical and electrical connections, and the first and second specific points are different points of the contact surface.

As discussed, in FIGS. 7 and 8, the barb 120 and the receiver clip connector 118 are both fully electrically conductive. As a result, there is a third contact surface 134 that provides a further electrical connection for the first connector assemblies 115. The third contact surface 134 also provides a further mechanical connection by resisting separation of the finish trim layer 105 from supporting structure 106 in at least a rightward direction as the receiver clip connector 118 is illustrated in FIG. 8.

The receiver clip connector 118 may be fixed to the frame member 107, and electrically connected to the first circuit portion 112 (shown in FIG. 2), using suitable means known to those skilled in the art. As non-limiting examples, the receiver clip connector 118 may be sewn or glued to the frame member 107. As further non-limiting examples, the receiver clip connector 118 may be electrically connected to the first circuit portion 112 (shown in FIG. 2) by a screw terminal or a soldered connection. Alternatively, as discussed, the receiver clip connector may be fixed to the finish trim layer 105 using suitable means known to those skilled in the art.

FIGS. 9 and 10 illustrate an alternate arrangement of the first connector assembly 115 to what is illustrated in FIGS. 7 and 8. In FIG. 9, the arrow connector 117 and the receiver clip connector 118 are in the disengaged state and, in FIG. 10, the arrow connector 117 and the receiver clip connector 118 are in the engaged state.

In FIGS. 9 and 10, an electrically conductive body member 119′ extends through the barb 120 to contact an electrically conductive tip rest 135 of the receiver clip connector 118. The tip rest 135 has a shape corresponding to the barb 120 and is adapted to receive or otherwise fit the extended body member 119′. In FIG. 10, the flanges 130 are electrically insulated. As a result, a second contact surface 133′ is between the extended body member 119′ and the tip rest 135. The second contact surface 133′ provides the electrical connection between the arrow connector 117 and the receiver clip connector 118. The second contact surface 133′ in FIG. 10 also provides an additional mechanical connection. The tip rest 135 resists separation of the finish trim layer 105 from supporting structure 106 in at least a rightward direction as the receiver clip connector 118 is illustrated in FIG. 10.

FIGS. 11 and 12 illustrate another alternate arrangement of the first connector assembly 115 to what is illustrated in FIGS. 7 and 8. In FIG. 11, the arrow connector 117 and the receiver clip connector 118 are in the disengaged state and, in FIG. 12, the arrow connector 117 and the receiver clip connector 118 are in the engaged state.

In FIGS. 11 and 12, the receiver clip connector 118 has an electrically insulated base portion 136 and there is a gap or other clearance between the barb 120 and the base portion 136. As a result, there is no third contact surface such as there is in FIG. 8.

As shown best in FIG. 13, the first connector assembly 115 preferably extends in a direction 137. The arrow connector 117 extends in the direction 137 and a plurality of the receiver clip connectors 118 are correspondingly arrayed along a support structure 138. As illustrated, the support structure 138 is electrically conductive between the receiver clips 118. The first connector assembly 115 extending in the direction 137 improves conductivity of the electrical connections and strength of the trim and electrical connections.

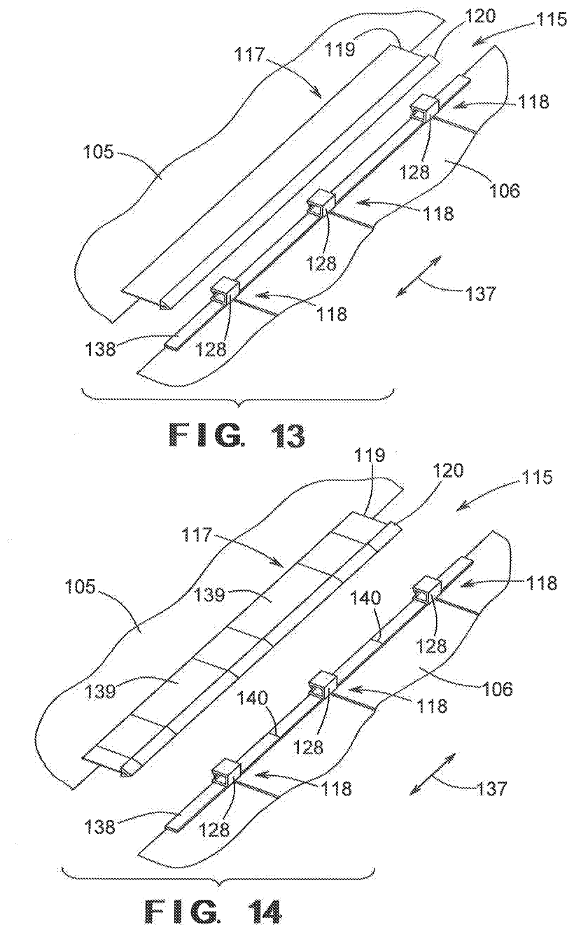

FIG. 14 illustrates an alternate arrangement of the first connector assembly 115 to what is illustrated in FIG. 13. In FIG. 14, first electrical insulator portions 139 are provided in the arrow connector 117 and second electrical insulator portions 140 are provided in the support structure 138. As a result, multiple, separate and independent, electrical circuits are provided between the finish trim layer 105 and the supporting structure 106.

FIGS. 15 and 16 illustrate the second connector assembly 116 in detail. In FIG. 15, the second connector assembly 116 is in a disengaged state and, in FIG. 16, the second connector assembly 116 is in an engaged state. The second connector assembly 116 may be utilized with existing assembly techniques, equipment, and best practices for installing the finish trim layer 105 on the supporting structure 106.

The second connector assembly 116 has first and second connectors 141 and 142, respectively. Each of the first and second connectors 141 and 142, respectively, is adapted as what is known to those skilled in the art as a “j-retainer.” The first j-retainer connector 141 has a first curved section 143 and a first hooked end 144. The second j-retainer connector 142 has a second curved section 145 and a second hooked end 146. The first and second hooked ends 144 and 146, respectively, have corresponding shapes. In the engaged state, shown in FIG. 16, the first and second hooked ends 144 and 146, respectively, engage together with each other at a contact surface 147.

The contact surface 147 resists separation of the first and second j-retainer connectors 141 and 142, respectively. As a non-limiting example, the contact surface 147 resists separation of the first and second j-retainer connectors 141 and 142, respectively, in at least one direction perpendicular to the contact surface 147. As a result, the contact surface 147 provides the mechanical connection for the second connector assembly 116. When the second connector assembly 116 is in the engaged state (shown in FIG. 16), the contact surface 147 also provides the electrical connection between the finish trim layer 105 and the supporting structure 106. As non-limiting examples, the first or second j-retainer connectors 141 and 142, respectively, may be fabricated from an electrically conductive material or an electrically conductive ink may be applied to non-electrically conductive material. Thus, the contact surface 147 is both a trim contact surface and an electrical contact surface.

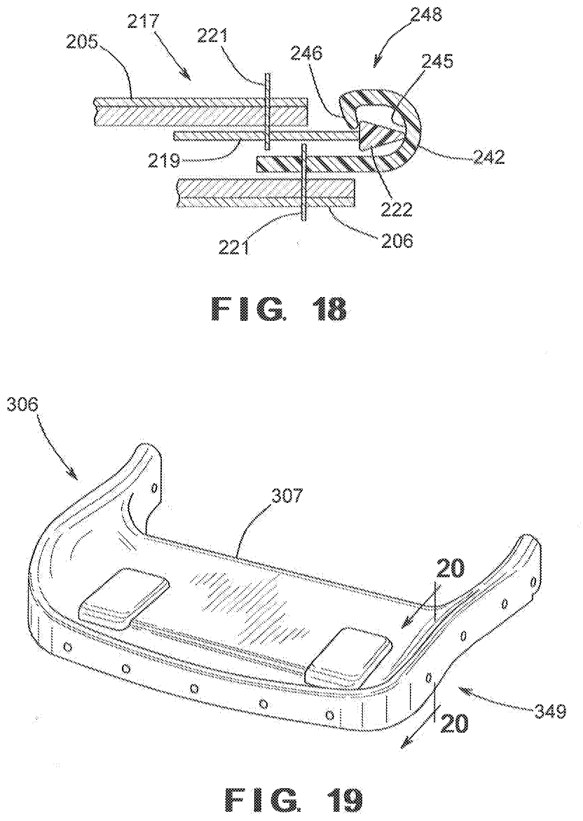

FIGS. 17 and 18 illustrated a third embodiment of a connector assembly, indicated generally at 248, for use with the vehicle seat 100 of FIG. 1. The third connector assembly 248 is a combination of the arrow connector 117 of the first connector assembly 115 (shown in FIGS. 3-14) and the first or second j-retainer connector 141 or 142, respectively, of the second connector assembly 116. As such, like reference numerals, increased by 100, designate corresponding parts in the drawings and detailed description thereof will be omitted. The third connector assembly 248 is illustrated in a disengaged state in FIG. 17 and in an engaged state in FIG. 18.

In FIG. 18, a barb 220 of an arrow connector 217 is engaged with a hooked end 246 of a j-retainer connector 242 at a contact surface 247. The contact surface 247 resists separation of the arrow connector 217 and the j-retainer connector 242. As a non-limiting example, the contact surface 247 resists separation of the arrow connector 217 and the j-retainer connector 242 in at least one direction perpendicular to the contact surface 247. The contact surface 247 is both a mechanical contact surface and an electrical contact surface that provides both the mechanical connection and the electrical connection.

FIG. 19 is a perspective view of a portion of the vehicle seat 100 of FIG. 1 with a fourth embodiment of a connector assembly, indicated generally at 349. The fourth connector assembly 349 is a variation of the second connector assembly 116 of FIGS. 15 and 16. As such, like reference numerals, increased by 200, designate corresponding parts in the drawings and detailed description thereof will be omitted. The fourth connector assembly 349 is illustrated as engaged with a frame member 307 for supporting the seat bottom 102 illustrated in FIG. 1.

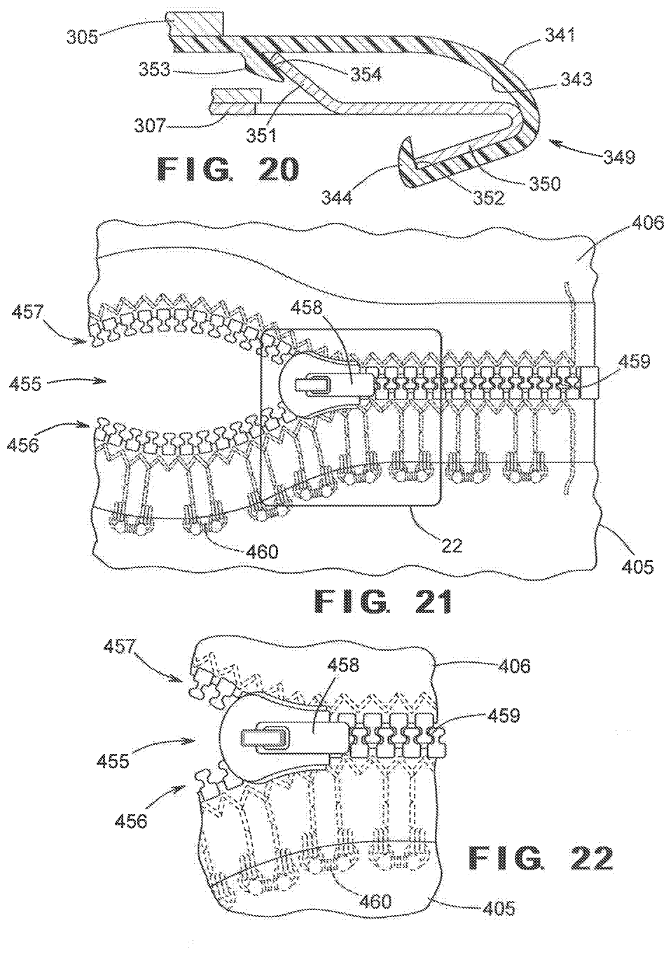

FIG. 20 illustrates the fourth connector assembly 349 in detail. The frame member 307 includes first and second flanges 350 and 351, respectively. The first flange 350 engages with a hooked end 344 of the fourth connector assembly 349 to establish a first contact surface 352. The second flange 351 engages with a retainer feature 353 of the fourth connector assembly 349 to establish a second contact surface 354. The first and second contact surfaces 352 and 354, respectively, establish both a mechanical connection and an electrical connection between the fourth connector assembly 349 and the frame member 307. Alternatively, the electrical connection may be established at only one of the first and second contact surfaces 352 and 354, respectively.

FIGS. 21 and 22 are partial elevational views of a fifth embodiment of a connector assembly, indicated generally at 455, for use with the vehicle seat 100 of FIG. 1. The fifth connector assembly 455 includes structure similar to that previously discussed with reference to the first and second connector assemblies 115 and 116, respectively, of FIGS. 1-16. As such, like reference numerals, increased by 300, designate corresponding parts in the drawings and detailed description thereof will be omitted. As illustrated, the fifth connector assembly 455 is in a partially engaged state.

A first portion, indicated generally at 456, of the fifth connector assembly 455 includes a plurality of electrically conductive first interlocking teeth and a second portion, indicated generally at 457, of the fifth connector assembly includes a plurality of electrically conductive second interlocking teeth. The first and second teeth 456 and 457, respectively, are selectively engaged or disengaged by a manually operated pull 458. The fifth connector assembly 455 is of a style commonly known as a “zipper.” Interlocking of the first and second teeth 456 and 457, respectively, provides a mechanical connection for the fifth connector assembly 455 at contact surfaces 459 between the first and second teeth 456 and 457, respectively.

The first and second teeth 456 and 457, respectively, are fabricated from an electrically conductive material. All, or less than all, of the first and second teeth 456 and 457, respectively, may be fabricated from the electrically conductive material. Alternatively, electrical conductivity may be added to a non-electrically conductive material (e.g., by using an electrically conductive ink, paint, or other finish). The contact surfaces 459 between the interlocking first and second teeth 456 and 457, respectively, provide an electrical connection for the fifth connector assembly 455.

Resistors 460 may be provided between the first teeth 456. The resistors 460 may indicate when the fifth connector assembly 455 is disengaged by reducing an electrical current flowing through the first teeth 456. When the fifth connector assembly 455 is engaged, the second teeth 457 allow the current to short circuit the resistors 460 and avoid the reduction in current. Alternatively, the resistors 460 may be provided between the second teeth 457.

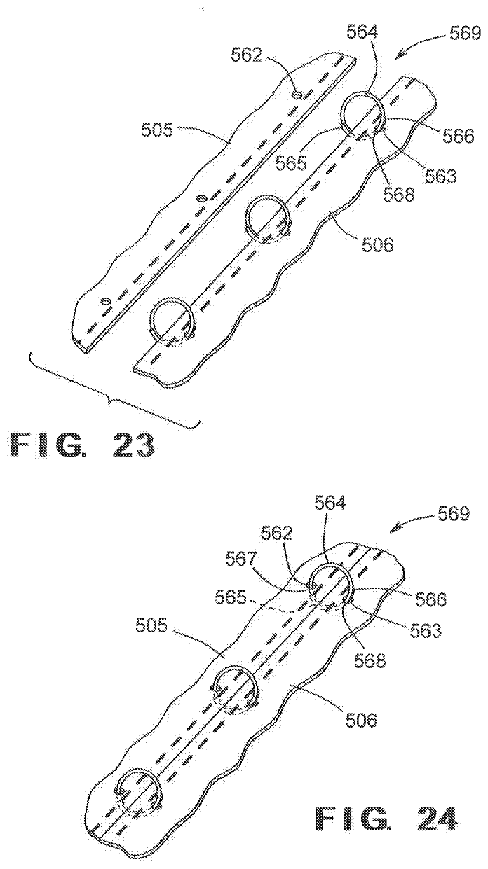

FIGS. 23 and 24 are perspective views of a sixth embodiment of a connector assembly, indicated generally at 561, for use with the vehicle seat 100 of FIG. 1. The sixth connector assembly 561 includes structure similar to that previously discussed with reference to the first and second connector assemblies 115 and 116, respectively, of FIGS. 1-16. As such, like reference numerals, increased by 400, designate corresponding parts in the drawings and detailed description thereof will be omitted. As illustrated, the sixth connector assembly 561 is in an engaged state. In FIG. 23, the connector assembly 561 is in a disengaged state and, in FIG. 24, the connector assembly 561 is in an engaged state.

At least one first opening or other penetration 562 is provided in a finish trim layer 505. Each of the first openings 562 has a corresponding second opening or other penetration 563 in a supporting structure 506. An electrically conductive connecting ring 564, commonly referred to as a “hog ring” by those skilled in the art passes through each pair of the corresponding first and second openings 562 and 563, respectively. A first portion 565 of the ring 564 passes through the first openings 562 and a second portion 566 of the ring 564 passes through the second openings 563. The ring 564 provides the trim and electrical connections between the supporting structure 506 and a finish trim layer 505.

There are first contact surfaces 567 between the first ring portions 565 and the finish trim layer 505 and second contact surfaces 568 between the second ring portions 566 and the supporting structure 506. Each of the first and second contact surfaces 567 and 568, respectively, provides a mechanical connection and an electrical connection for the sixth connector assembly 561. Each of the first or second openings 562 or 563, respectively, may be dimensioned such that the first or second contact surface 567 or 568, respectively, is for a full circumference of the first or second opening 562 or 563, respectively. For example, the first or second opening 562 or 563, respectively, may have a diameter equal to the ring 564. Alternatively, each of the first or second openings 562 or 563, respectively, may be dimensioned such that the first or second contact surface 567 or 568, respectively, is for less than the full circumference of the first or second opening 562 or 563, respectively. This may occur when the first or second opening 562 or 563, respectively, has a diameter less than a diameter of the ring 564.

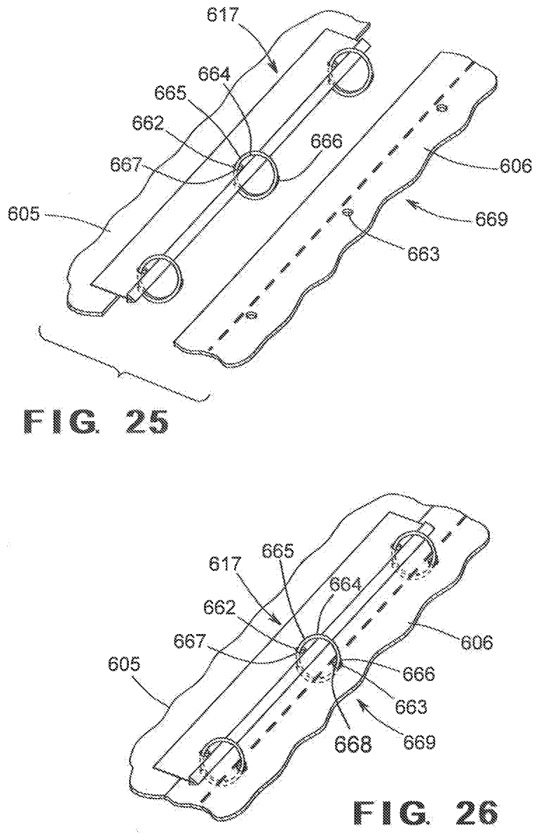

FIGS. 25-26 are perspective views of a seventh embodiment of a connector assembly, indicated generally at 669, for use with the vehicle seat 100 of FIG. 1. The seventh connector assembly 669 includes structure similar to that previously discussed with reference to the first and second connector assemblies 115 and 116, respectively, of FIGS. 1-16. As such, like reference numerals, increased by 500, designate corresponding parts in the drawings and detailed description thereof will be omitted. As illustrated, the seventh connector assembly 669 is in an engaged state.

An arrow connector, indicated generally at 617, is provided with at least one first opening or other penetration 662. Each of the first openings 662 has a corresponding second opening or other penetration 663 in a supporting structure 606. An electrically conductive connecting ring, indicated generally at 664 and commonly referred to as a “hog ring” by those skilled in the art, passes through each pair of the corresponding first and second openings 662 and 663, respectively. The ring 664 provides the trim and electrical connections between the supporting structure 606 and a finish trim layer 605. The first openings 662, second openings 663, ring 664, first ring portion 665, and second ring portion 666 correspond to the first openings 562, second openings 563, ring 564, first ring portion 565, and second ring portion 566 of FIGS. 23 and 24 and detailed description of the first openings 662, second openings 663, ring 664, first ring portion 665, and second ring portion 666 will be omitted.

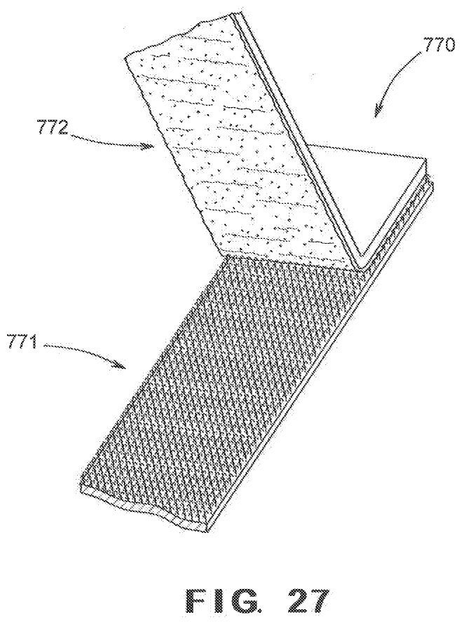

FIG. 27 is a partial perspective view of an eighth embodiment of a connector assembly, indicated generally at 770 for use with the vehicle seat 100 of FIG. 1. The eighth connector assembly 770 includes structure similar to that previously discussed with reference to the first and second connector assemblies 115 and 116, respectively, of FIGS. 1-16. As such, like reference numerals, increased by 600, designate corresponding parts in the drawings and detailed description thereof will be omitted. As illustrated, the eighth connector assembly 770 is in a disengaged state.

A first portion, indicated generally at 771, of the eighth connector assembly 770 includes a plurality of electrically conductive first hooks and a second portion, indicated generally at 772, of the eighth connector assembly 770 includes a plurality of electrically conductive loops. The hooks and loops 771 and 772, respectively, are selectively engaged or disengaged by pressing together or pulling apart the finish trim layer 705 and the supporting structure 706. The eighth connector assembly 770 is of a hook and loop fastener style commonly known, and commercially available, as “Velcro.” Interlocking of the hooks and loops 771 and 772, respectively, at contact surfaces (when the hooks and loops 771 and 772, respectively, are engaged) provides both a mechanical connection and an electrical connection for the eighth connector assembly 770.

In the described embodiments, a first portion of the connector assembly is fixed to the finish trim layer 105 and a second portion of the connector assembly is fixed to the supporting structure 106. Alternatively, for each of the embodiments, the first portion may be fixed to the supporting structure 106 and the second portion may be fixed to the finish trim layer 105.

As discussed, the electrical connections provided by the connector assemblies discussed with respect to FIGS. 1-27 are provided without altering external dimensions that the connector assemblies would otherwise have were the electrical connections omitted (e.g., were the first and second attachment circuits omitted). As a result, the discussed connector assemblies may be utilized with existing assembly techniques, equipment, and best practices for installing the finish trim layer 105 on the supporting structure 106.

The connector assemblies not limited to the specific connector assemblies discussed with respect to FIGS. 1-27. As non-limiting examples, the connector assemblies may alternative include Christmas tree style, push-in clip, screw and socket, nut and bolt, rivet, or other types or styles of selectively engagable connector assemblies. Again, addition of the electrical connection to known styles of connector assemblies does not alter external dimensions of the connector assemblies.

The principle and mode of operation of this invention have been explained and illustrated in its preferred embodiments. However, it must be understood that this invention may be practiced otherwise than as specifically explained and illustrated without departing from its spirit or scope.

1-20. (canceled)

21. A portion of a vehicle seat that is adapted for use with a vehicle having an electrical circuit, the portion of the vehicle seat comprising:
a seat bottom or a seat back that is adapted to support an occupant of a vehicle and that includes:
(1) a frame that is adapted to be supported within a vehicle and that has a first connector that is (a) mechanically supported on the frame and (b) adapted to be electrically connected to an electrical circuit provided in a vehicle; and
(2) a trim layer having an electrically conductive circuit portion and a second connector that is (a) mechanically connected to the trim layer and (b) electrically connected to the electrically conductive circuit portion,
wherein the second connector is mechanically and electrically connected to the first connector.

22. The portion of a vehicle seat defined in claim 21 wherein a first one of the first and second connectors includes an electrically conductive body member and a barb.

23. The portion of a vehicle seat defined in claim 22 wherein a second one of the first and second connectors includes an electrically conductive body portion that is mechanically and electrically connected to the first one of the first and second connectors.

24. The portion of a vehicle seat defined in claim 23 wherein the second one of the first and second connectors includes a flange that engages the barb on the first one of the first and second connectors.

25. The portion of a vehicle seat defined in claim 21 wherein the frame has a plurality of first connectors, and wherein the trim layer has a plurality of second connectors mechanically and electrically connected to the plurality of first connectors.

26. The portion of a vehicle seat defined in claim 21 wherein each of the first and second connectors includes an electrically conductive j-retainer.

27. The portion of a vehicle seat defined in claim 21 wherein a first one of the first and second connectors includes an electrically conductive body member and a barb, and wherein a second one of the first and second connectors includes an electrically conductive j-retainer.

28. The portion of a vehicle seat defined in claim 21 wherein each of the first and second connectors includes a plurality of electrically conductive teeth.

29. The portion of a vehicle seat defined in claim 28 further including a pull for selectively connecting and disconnecting the pluralities of electrically conductive teeth.

30. The portion of a vehicle seat defined in claim 21 wherein the second connector is mechanically and electrically connected to the first connector by an electrically conductive ring.

31. A vehicle seat that is adapted for use with a vehicle having an electrical circuit, the vehicle seat comprising:
a seat bottom; and
a seat back that, together with the seat bottom, is adapted to support an occupant of a vehicle, wherein at least one of the seat bottom and the seat back includes:
(1) a frame that is adapted to be supported within a vehicle and that has a first connector that is (a) mechanically supported on the frame and (b) adapted to be electrically connected to an electrical circuit provided in a vehicle; and
(2) a trim layer having an electrically conductive circuit portion and a second connector that is (a) mechanically connected to the trim layer and (b) electrically connected to the electrically conductive circuit portion,
wherein the second connector is mechanically and electrically connected to the first connector.

32. The vehicle seat defined in claim 31 wherein a first one of the first and second connectors includes an electrically conductive body member and a barb.

33. The vehicle seat defined in claim 32 wherein a second one of the first and second connectors includes an electrically conductive body portion that is mechanically and electrically connected to the first one of the first and second connectors.

34. The vehicle seat defined in claim 33 wherein the second one of the first and second connectors includes a flange that engages the barb on the first one of the first and second connectors.

35. The vehicle seat defined in claim 31 wherein the frame has a plurality of first connectors, and wherein the trim layer has a plurality of second connectors mechanically and electrically connected to the plurality of first connectors.

36. The vehicle seat defined in claim 31 wherein each of the first and second connectors includes an electrically conductive j-retainer.

37. The vehicle seat defined in claim 31 wherein a first one of the first and second connectors includes an electrically conductive body member and a barb, and wherein a second one of the first and second connectors includes an electrically conductive j-retainer.

38. The vehicle seat defined in claim 31 wherein each of the first and second connectors includes a plurality of electrically conductive teeth.

39. The vehicle seat defined in claim 38 further including a pull for selectively connecting and disconnecting the pluralities of electrically conductive teeth.

40. The vehicle seat defined in claim 31 wherein the second connector is mechanically and electrically connected to the first connector by an electrically conductive ring.
